(19) United States
(12) Patent Application Publication
(10) Pub. No.: US 2009/0004543 A1
(43) Pub. Date: Jan. 1, 2009

(54) MEMBRANE ELECTRODE ASSEMBLIES FOR FUEL CELLS AND METHODS OF MAKING

(76) Inventors: Seungsoo Jung, Vancouver (CA); Bien H. Chiem, Burnaby (CA); Sybel M. Chor, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/769,583

(22) Filed: Jun. 27, 2007

(51) Int. Cl. H01M 4/86; H01M 4/88; H01M 8/02; H01M 8/24

(52) U.S. Cl. 429/36; 29/623.2; 429/40

(57) ABSTRACT

A sealed unbonded membrane electrode assembly includes a first gas diffusion layer and a second gas diffusion layer each having a peripheral border and an active region a catalyst coated membrane, having an active region, interposed between the first gas diffusion layer and the second gas diffusion layer; and a frame member; wherein the frame member envelops the peripheral border of the first gas diffusion layer and the second gas diffusion layer and is sealed to the catalyst-coated membrane; and wherein the catalyst-coated membrane is unbonded to the first and second gas diffusion layers in the active regions thereof.

### BACKGROUND

1. Technical Field

The present disclosure relates to membrane electrode assemblies for fuel cells and methods of making the same. More specifically, the present disclosure relates to sealed, unbonded membrane electrode assemblies.

2. Description of the Related Art

Fuel cells convert fuel and oxidant to electricity and reaction product. Proton exchange membrane fuel cells employ a membrane electrode assembly (“MEA”) consisting of a proton exchange membrane (“PEM”) (also known as an ion-exchange membrane) interposed and bonded between two electrodes formed of porous, electrically conductive sheet material, typically carbon fiber paper. A catalyst layer, such as platinum, is disposed on the surface of the electrically conductive sheet material or on the proton exchange membrane. The MEA is further interposed between two fluid flow plates to form a fuel cell assembly. The plates allow access of reactants to the MEA, act as current collectors, and provide support for the adjacent electrodes. A plurality of fuel cell assemblies may be combined to form a fuel cell stack.

At the anode, fuel, typically in the form of hydrogen gas, reacts at the catalyst layer to form hydrogen ions, protons, and electrons. At the cathode, oxidant reacts at the catalyst layer to form anions. The PEM isolates the fuel stream from the oxidant stream and facilitates the migration of the protons from the anode to the cathode where they react with anions formed at the cathode. The electrons pass through an external circuit, creating a flow of electricity. The net reaction product is water. The anode and cathode reactions in hydrogen/oxidant fuel cells are shown in the following equations:

H₂→2H⁺+2e⁻ (1)

½O₂+2H⁺+2e⁻→H₂O (2)

Typical methods of making an MEA include applying a layer of catalyst to a gas diffusion layer in the form of an ink or a slurry which contains particulates and dissolved solids mixed in a suitable liquid carrier. The liquid carrier is then removed or evaporated to leave a layer of particulates and dispersed solids on the surface of the gas diffusion layer to form an electrode. Alternatively, a layer of anode catalyst and cathode catalyst may be coated onto opposing surfaces of the PEM to form a catalyst-coated or catalyzed membrane. The PEM may then be disposed between the electrically conductive sheet materials of the anode and cathode where they are typically bonded, usually under heat and pressure, to ensure sufficient proton conduction from the catalyst layer to the membrane. In the case of an MEA using a catalyst-coated membrane, an ionomer spray coat may be employed at the interface of the gas diffusion layer and the catalyst-coated membrane to improve bonding at lower temperatures and pressures, such as that described in U.S. Patent Application No. 2004/0258979. The ionomer spray coat may also contain a carbon such as carbon black, graphite, carbon nanotubes, meso-carbon microbeads, or the like.

A bonded MEA is normally sealed around its peripheral edge to prevent intermixing of the reactants and coolant, for example, by methods described in U.S. Pat. Nos. 5,464,700 and 7,070,876.

The act of bonding the PEM to the other layers of the MEA is however, fastidious and time consuming, particularly when bonding is conducted between heated platens. For example, bonding methods known in the art require specific heating and cooling cycles of the platens, generating a lag time between bonding of successive MEAs, to allow the platens to heat up to the desired temperature, reach equilibrium and then cool down. Furthermore, if the temperature and/or pressure are too high, and/or the bonding time is too long, then the proton exchange membrane may be damaged. However, if the temperature and/or pressure are too low, and/or the bonding time is too short, the MEA may be insufficiently bonded. Furthermore, additional care must be exercised to ensure that pressure and heat are evenly applied and distributed during bonding to ensure that the MEA components are uniformly bonded to each other. Such even pressure and heating are typically difficult to obtain for MEAs with a large surface area.

As a result, there remains a need to improve methods of making MEA that does not include a fastidious and time consuming bonding step. The present invention addresses these issues and provides further related advantages.

### BRIEF SUMMARY

In one embodiment, a sealed unbonded membrane electrode assembly comprises a first gas diffusion layer and a second gas diffusion layer each having a peripheral border and an active region; a catalyst-coated membrane, having an active region, the catalyst-coated membrane interposed between the first gas diffusion layer and the second gas diffusion layer; and a frame member that envelops the peripheral border of the first gas diffusion layer and the second gas diffusion layer and is sealed to the catalyst-coated membrane; and wherein the catalyst-coated membrane is unbonded to the first and the second gas diffusion layers in the active regions thereof.

In one embodiment, the catalyst-coated membrane has a perimeter edge that does not extend beyond the peripheral border of the first and the second gas diffusion layers.

In another embodiment, the catalyst-coated membrane has a perimeter edge that extends beyond the perimeter edge of the first and the second gas diffusion layers.

In one embodiment, the catalyst-coated membrane has a peripheral border and wherein the frame member is sealed to the peripheral border of the catalyst-coated membrane.

In one embodiment, the frame member impregnates the peripheral border of the first and the second gas diffusion layers.

In one embodiment, the frame member is formed from an injection moldable material.

In another embodiment, the frame member comprises a first frame submember and a second frame submember sealed to each other.

In another embodiment, the first and the second frame submembers each have opposing contacting surfaces wherein at least one of the first and second frame submembers further comprises an adhesive disposed on its contacting surface.

In another embodiment, the sealed unbonded membrane electrode assembly further comprises a third gas diffusion layer interposed between the first gas diffusion layer and the catalyst-coated membrane, wherein an effective water diffusion constant of the first gas diffusion layer is less than an effective water diffusion constant of the third gas diffusion layer.

In another embodiment, a fuel cell stack comprises a plurality of fuel cells, each fuel cell comprising a sealed unbonded membrane electrode assembly, the sealed unbonded membrane electrode assembly comprising: a first gas diffusion layer and a second gas diffusion layer each having a peripheral border and an active region; a catalyst-coated membrane, having an active region, the catalyst-coated membrane interposed between the first gas diffusion layer and the second gas diffusion layer; and a frame member; wherein the frame member envelops the peripheral border of the first gas diffusion layer and the second gas diffusion layer and is sealed to the catalyst-coated membrane; and wherein the catalyst-coated membrane is unbonded to the first and the second gas diffusion layers in the active regions thereof.

In yet another embodiment, a method of making a sealed unbonded membrane electrode assembly comprises: providing a first gas diffusion layer, a second gas diffusion layer, each comprising a peripheral border and an active region; and a catalyst-coated membrane interposed therebetween, the catalyst-coated membrane having a perimeter edge and an active area, enveloping the peripheral borders of the first and the second gas diffusion layers with a first frame member; and sealing the first frame member to the perimeter edge of the catalyst-coated membrane, wherein the catalyst-coated membrane is not bonded to the first and the second gas diffusion layers in the active areas thereof.

These and other aspects of the various embodiments will be evident from the attached drawings and following detailed description.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1 is an exploded perspective diagram of a sealed unbonded membrane electrode assembly according to one illustrated embodiment.

FIG. 2 is a cross-sectional diagram of a sealed unbonded membrane electrode assembly according to one illustrated embodiment.

FIG. 3 is a cross-sectional diagram of a sealed unbonded membrane electrode assembly according to another illustrated embodiment.

FIG. 4 is a cross-sectional diagram of a sealed unbonded membrane electrode assembly according to yet another embodiment.

FIG. 5 is a cross-sectional diagram of a sealed unbonded membrane electrode assembly according to yet another embodiment.

FIG. 6A is a cross-sectional diagram of a sealed unbonded membrane electrode assembly according to yet another embodiment.

FIG. 6B is a cross-sectional diagram of a sealed unbonded membrane electrode assembly according to yet another embodiment.

FIG. 6C is a cross-sectional diagram of a sealed unbonded membrane electrode assembly according to yet another embodiment.

FIG. 6D is a cross-sectional diagram of a sealed unbonded membrane electrode assembly according to yet another embodiment.

FIG. 7 is a graph of exemplary fuel cell performance.

### DETAILED DESCRIPTION

The headings and Abstract of the Disclosure provided herein are for convenience only and do not interpret the scope or meaning of the embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with fuel cells, MEAs, fluid flow plates, and/or PEMs have not been shown or described in detail to avoid unnecessarily obscuring descriptions of the embodiments.

Unless the context requires otherwise, throughout the specification and claims which follow, the word “comprise” and variations thereof, such as “comprises” and “comprising” are to be construed in an open, inclusive sense, that is as “including but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein and in the appended claims, “unbonded” means that the major surface of the gas diffusion layer is not attached to the corresponding contacting major surface of the catalyst-coated membrane.

In the present context, “sealed” should not be understood necessarily as hermetically sealed. Instead, a membrane electrode assembly is “sealed” if, in operation, intermixing of the various fluids flowing across opposing sides of the membrane electrode assembly is sufficiently restricted so that fuel cell performance, durability and safety are not unduly compromised.

The present teachings are particularly suitable for PEM MEAs, though those of ordinary skill in the art will appreciate that they may be employed with other types of MEAs.

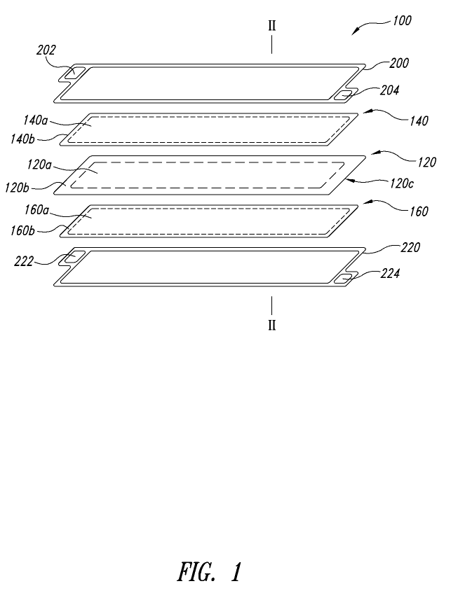

FIG. 1 shows an exploded perspective diagram of a non-flush-cut sealed unbonded MEA 100 according to one illustrated embodiment. MEA 100 includes a catalyst-coated membrane (“CCM”) 120 disposed between an anode gas diffusion layer (“GDL”) 140 and a cathode GDL 160. CCM 120, anode GDL 140 and cathode GDL 160 are further disposed between a first sealing frame 200 and second sealing frame 220. Anode GDL 140 and cathode GDL 160 have an active region 140a and 160a, designated by the region enclosed by the broken line, respectively, and a peripheral border 140b, and 160b designated by the area outside the broken line, respectively. CCM 120 likewise has an active region 120a, designated by the region enclosed by the broken line, and a peripheral border 120b designated by the area outside the broken line. CCM 120 also has a perimeter edge 120c. In this embodiment, the perimeter edge 120c of CCM 120 extends beyond the peripheral borders 140b, 160b of anode and cathode GDL 140, 160.

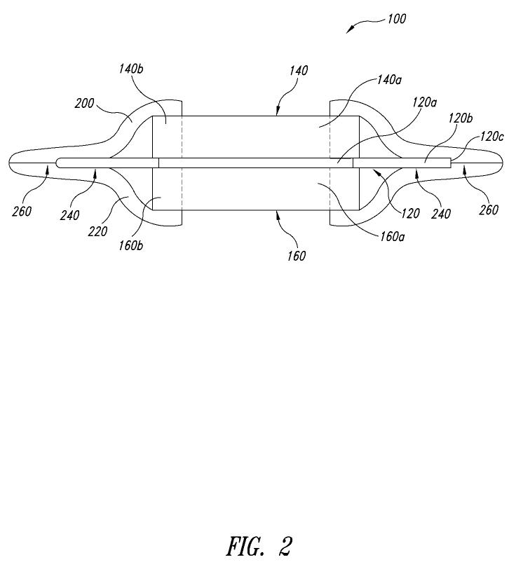

FIG. 2 is a cross sectional diagram of MEA 100, taken along line II-11 of FIG. 1. In FIG. 1 the first sealing frame 200 is positioned on the outer surface of anode GDL 140 and a second sealing frame 220 is positioned on the outer surface of cathode GDL 160. Sealing frames 200, 220 collectively envelope the peripheral borders 120b, 140b and 160b of CCM 120, anode GDL 140, and cathode GDL 160 respectively. Sealing frames 200, 220 are sealed to the perimeter edge 120c of CCM 120 and may extend beyond CCM 120 where they are further sealed to one another in regions 260. A person of ordinary skill in the art will readily recognize that sealing frames 200, 220 may seal to the peripheral border 120b of CCM 120 in addition to or rather than sealing to the perimeter edge 120c of CCM 120.

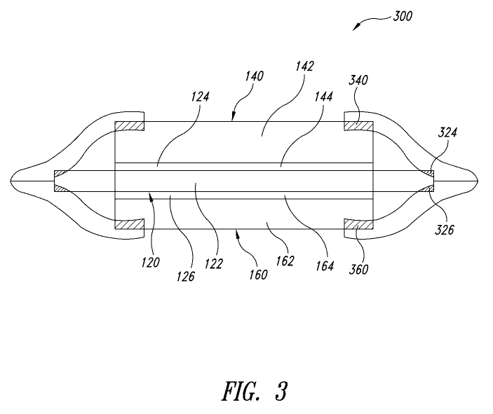

FIG. 3 is a cross sectional diagram of a non-flush-cut sealed, unbonded MEA 300 according to another embodiment. In this embodiment, CCM 120 is comprised of a PEM 122 with anode and cathode catalyst layers 124, 126 disposed on opposing major surfaces thereof. Anode and cathode GDLs 140, 160 also are further comprised of an anode and cathode substrate 142, 162, and an anode and cathode sublayer 144, 164, respectively. The anode and cathode sublayers 144, 164 penetrate into at least a portion of the respective anode and cathode substrates 142, 162. In at least some of the embodiments described herein, sealing frames 200, 220 may include an adhesive. In the embodiment depicted in FIG. 3, the adhesive and/or the sealing frame has penetrated into or has impregnated the pores of peripheral edges 140b, 160b of anode and cathode GDLs 140, 160 or in particular, the anode and cathode substrate 142, 162 as shown by hatched lines in region 340 and 360 respectively. Adhesive and/or sealing frame may also penetrate into the anode and cathode catalyst layers 124, 126 of CCM 120 as shown by hatched lines in regions 324 and 326 respectively in the embodiment depicted in FIG. 3.

Examples of suitable anode and cathode substrates 142, 162 are electrically conductive and porous materials including carbon fiber papers, such as the TGP-H material supplied by Toray Industries, Inc. (Japan) and the AvCarb® material supplied by Ballard Material Products, Inc. (Lowell, Mass.), as well as perforated flexible expanded graphite sheets, such as that described in U.S. Patent Application No. 2003/0108731. Additionally, a hydrophobic material, such as polytetrafluoroethylene (PTFE) (not shown), may be dispersed in any of anode substrate 142, cathode substrate 162, anode sublayer 144, and cathode sublayer 164. In some instances, additional sublayers (not shown) may be employed on anode sublayer 144 and/or cathode sublayer 164. Such additional sublayers may contain the same or different constituents in similar or different amounts. One skilled in the art will readily select a suitable anode and cathode GDL materials and sublayers for a given set of fuel cell operating conditions. The use of any of the sublayers is optional.

PEM 120 may be perfluorinated, partially-fluorinated, or non-fluorinated. Exemplary examples of suitable polymer electrolyte membranes include Nafion® (supplied by DuPont™), Gore-Select® (supplied by Gore™), BAM® (supplied by Ballard Power Systems, Inc., Canada), and Aciplex® (supplied by Asahi Kasei Corp., Japan). The anode and cathode catalyst layers 122, 124 may include precious metals, such as platinum, ruthenium, or mixtures or alloys thereof, that may be supported on an electrically-conductive support, such as carbon, or unsupported. Alternatively, the anode and cathode catalyst layers 122, 124 may include a non-noble metal catalyst such as a chalcogenide. One skilled in the art will readily select a suitable PEM material and catalyst material for a given set of fuel cell operating conditions. In some embodiments the anode and cathode catalyst layers 122, 124 may extend beyond the active regions 120a of CCM 120 into peripheral border 120b, for ease of manufacture, for example, but need not extend beyond the active region 120a. Not extending anode and cathode catalyst layers 122, 124 beyond active region 120a reduces the net catalyst material required.

Sealing frames 200, 220 may be polyesters, polyethylenes, polypropylenes, polyimides, and thermosets. The sealing frame may be a rigid laminate material that imparts a desired rigidity to the resulting sealed MEA after sealing. As noted, sealing frames may also contain a pressure-activated adhesive, such as a silicone or acrylic-based adhesive, or may contain a thermally-activated adhesive that may be a thermoset, a thermoplastic, or combinations thereof. One skilled in the art will readily select a suitable frame material and adhesive material for a given set of fuel cell operating conditions. Sealing frames 200, 220 may further have wing areas including ports for the transport of reactants and reaction products as seen in FIG. 1 as designated by areas 202, 204, 222, and 224.

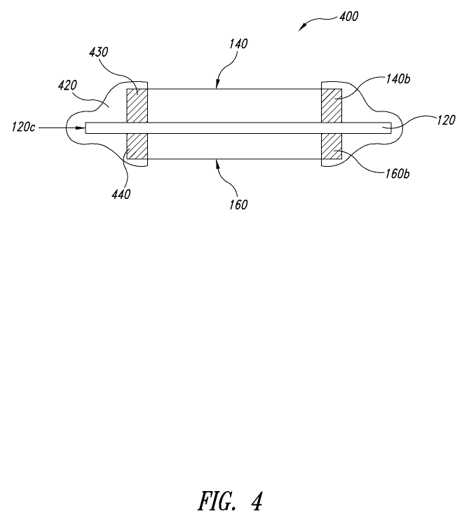

FIG. 4 shows a cross sectional diagram of non-flush-cut sealed, unbonded MEA 400 according to another illustrated embodiment including seals 420 of the liquid injection molding variety. Seals 420 may seal the CCM 120 by penetrating or impregnating the pores of peripheral borders 140b, 160b of the anode and cathode GDLs 140, 160 thereby preventing reactants from leaking around CCM 120 at the edge of the anode and cathode GDLs 140, 160. Seals 420 may further seal CCM 120 by sealing the peripheral border 120b and/or perimeter edge 120c of CCM 120. Impregnated regions of the anode and cathode GDLs are indicated in FIG. 4 by the hatched areas 430 and 440 respectively. Further, the impregnated material serves to provide structural integrity to MEA 400. For greater seal and structural integrity, it is advantageous for seals 420 to extend beyond the peripheral borders 140b, 160b of anode and cathode GDLs 140, 160 to encapsulate the entire end of MEA 400.

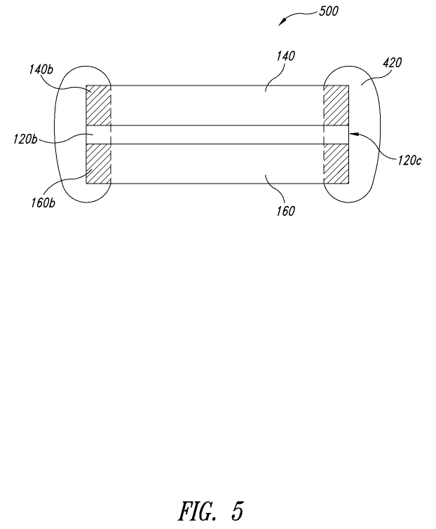

FIG. 5 shows a cross sectional diagram of a flush-cut sealed, unbonded MEA 500 according to another illustrated embodiment where the peripheral border 120b and perimeter edge 120c of CCM 120 does not substantially extend beyond the peripheral borders 140b, 160b of the anode and cathode GDL 140, 160. Seals 420 are of the liquid injection molding variety discussed above and penetrate the pores of anode and cathode GDLs 140, 160 and seal to CCM 120.

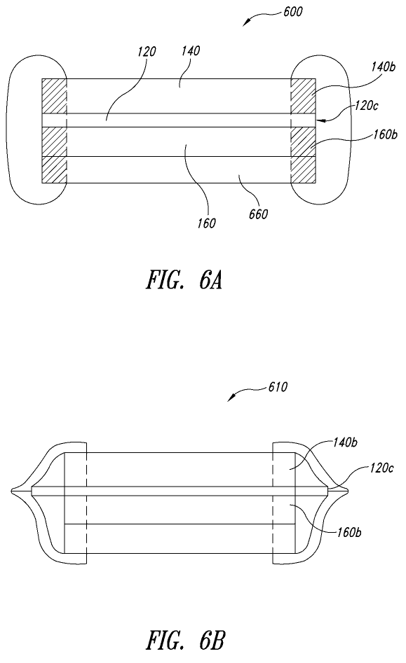

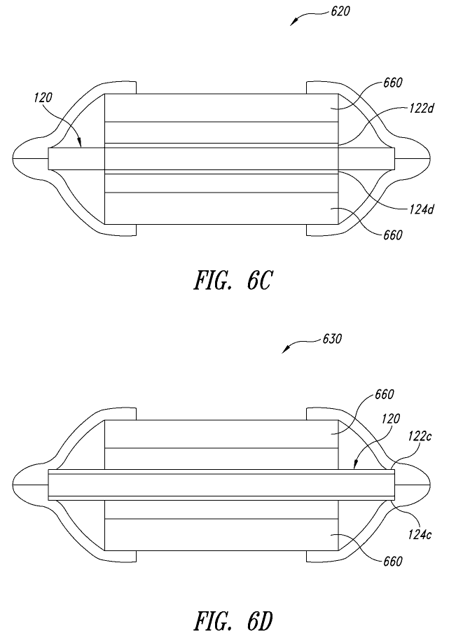

In some embodiments, the sealed unbonded MEA may be used in fuel cells that operate with no external humidification. This is achieved by maintaining sufficient hydration in the proton exchange membrane, as described in U.S. Pat. No. 6,451,470, for example. Hydration may be maintained by optimizing the effective diffusion constants of the anode and cathode GDLs 140, 160 so that they maintain water resultant from the fuel cell operation. The effective diffusion constants of the anode and/or cathode GDLs may be modified in a number of ways, as described in U.S. Pat. No. 6,451,470. In particular, the effective water diffusion constant on the anode and/or cathode GDLs can be reduced by including an additional gas diffusion layer, (“AGDL”) 660 on either the anode side, cathode side or both. The AGDL 660 is an electrically conductive and porous material positioned such that the anode and/or cathode GDL 140, 160 is interposed between the AGDL 660 and CCM 120. FIG. 6A shows a flush-cut sealed unbonded MEA 600 with an AGDL 660 on the cathode side where the perimeter edge 120c of the CCM 120 does not extend beyond the peripheral borders 140b, 160b of the anode and cathode GDLs 140, 160. FIG. 6B shows a non-flush-cut sealed unbonded MEA 610 with an AGDL 660 where the perimeter edge 120c of the CCM 120 substantially extends beyond the peripheral edges 140b, 160b of the anode and cathode GDLs 140, 160. FIGS. 6C and 6D show non-flush-cut sealed unbonded MEA 620 and 630 respectively with AGDL 660 on both the anode and cathode sides. FIG. 6C shows CCM 120 where the anode and cathode catalyst layers 122d and 124d do not extend beyond the active region 120a of CCM 120. FIG. 6D shows CCM 120 where the anode and cathode catalyst layers 122e and 124e do not extend beyond the active region 120a of CCM 120.

A sealed unbonded MEA may be made as described below. Each of the anode GDL, cathode GDL, CCM, and AGDL (where employed) are prepared and then cut to the appropriate dimensions. Any method known in the art for cutting may be used, such as die cutting, laser cutting, and the like. Opposing sealing frames are placed into a sealing apparatus where a first fixture holds a first sealing frame and a second fixture holds a second sealing frame with a space interposed therebetween.

Each MEA component, the anode GDL, cathode GDL, CCM and AGDL, where employed, is placed onto or in the first and/or second fixtures in the appropriate order. If the MEA components are cut using a die cutter, the rule die used for die cutting may be equipped with a vacuum apparatus that allows the uncut component to be punched out in the rule die and transported to the sealing apparatus. In some embodiments, the rule die may include alignment means, such as alignment pins or holes that align with corresponding alignment holes or pins in the first and/or second fixtures, to ensure alignment of the component with the sealing frames.

After the MEA components are placed into the sealing apparatus, heat and/or pressure are then applied on the sealing frames via sealing fixtures to seal the sealing frames to the MEA components and to each other. After sealing, the first and second fixtures are then separated and the sealed MEA is removed. One skilled in the art may readily opt to use an adhesive material and select a suitable adhesive that requires simple sealing conditions and/or short sealing durations while ensuring that the components are sufficiently attached.

Because heat and/or pressure are applied only on the sealing frames, the MEA components are not bonded to each other. As mentioned before, MEAs are typically bonded to ensure sufficient proton conduction from the catalyst to the membrane. The bonding process is typically complex and often requires specific heating and cooling cycles for most membranes and/or long bonding durations, which is time consuming and not practical for large scale manufacturing purposes. However, it has been surprisingly discovered that when using CCMs, bonding of the MEA is not necessary when operating at low current densities, for example, equal to or less than about 0.6 A/cm². As a result, the MEA does not need to be bonded.

In one example, anode GDL and CCM may be placed into a first fixture while cathode GDL may be placed in a second fixture. When the vacuum is activated in the first fixture, first sealing frame, anode GDL, and CCM are held in place because anode GDL is porous. Thus, movement of the components is reduced. Similarly, when the vacuum is activated in the second fixture, second sealing frame and cathode GDL are also held in place because cathode GDL is also porous. In some embodiments, an AGDL may be employed such that the anode and/or cathode GDL is interposed between the AGDL and the CCM.

### EXAMPLES

Two fuel cells FC-A and FC-B were prepared. FC-A and FC-B were identical except that the MEA in FC-A (MEA-A) was bonded whereas the MEA in FB-B (MEA-B) was not. Surprisingly, almost no performance difference was observed between the FC-A and FC-B

MEA-A and MEA-B were made having 49 cm² active area using the following components in the order described.

| Component | Description |
|---|---|
| Anode GDL-1 | GRAFCELL ® TG-523B-10 substrate |
| Anode GDL-2 | AvCarb ® P50T with 14.2% PTFE |
| Catalyst-coated | GORE ® Primea ® Series 5561 |
| membrane | 25 μm membrane thickness |
| | 0.45 mg Pt alloy/cm² anode catalyst |
| | 0.40 mg Pt/cm² cathode catalyst |
| Cathode GDL-2 | AvCarb ® P50T with 14.2% PTFE |
| Cathode GDL-1 | GRAFCELL ® TG-523B-6 substrate |

Sealing frames consisting of Kapton® sheets with a silicone-based adhesive were placed on either side of the CCM, and attached to the peripheral edge of the CCM and to each other by applying hand pressure. Each of the GDLs were cut to the size of the active region and placed thereon. Anode GDL-2 and cathode GDL-2 were placed on opposing sides of the sealed CCM.

As noted, MEA-B was not bonded whereas MEA-A was bonded by heating the components to 160° C. and simultaneously compressing the components at 10 bar for 2 minutes. The bonded assembly was removed from the bonding fixture and assembled with the anode GDL-1 contacting the anode GDL-2 and the cathode GDL-1 contacting the cathode GDL-2, between two graphite plates. Elastomeric seals were pressed against the sealing frames by the plates to prevent the fluids from leaking out between the frames and the plates.

Both FC-A and FC-B were conditioned at 530 mA/cm² at 62° C. overnight with a hydrogen stoichiometry of 1.2 and an air stoichiometry of 10. Both the hydrogen and air were supplied at ambient pressures. After the fuel cells were conditioned, they were subjected to a polarization test.

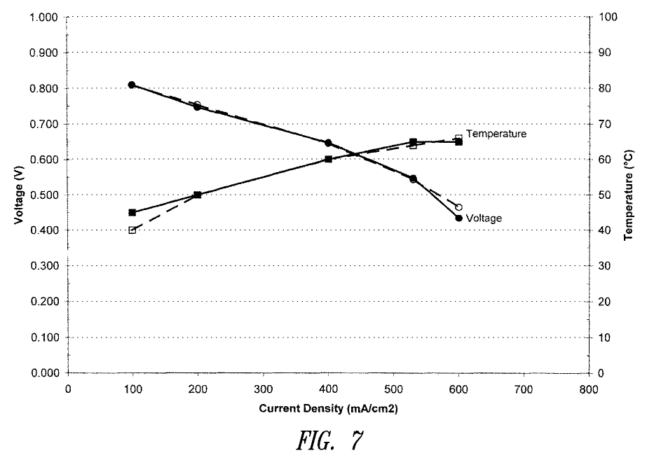

FIG. 7 shows a graph of current density versus voltage for FC-A and FC-B. The performance of FC-A is indicated by a solid line where the performance of FC-B is indicated by a broken line. The lines with a positive slope indicate temperature. The lines with a negative slope indicate voltage. As shown in FIG. 7, surprisingly, almost no performance difference was observed between the FC-A and FC-B

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to MEAs, not necessarily the exemplary PEM MEAs generally described above.

The various embodiments described above can be combined to provide further embodiments. To the extent that they are not inconsistent with the specific teachings and definitions herein, all of the above U.S. patents, U.S. patent application publications, U.S. patent applications, foreign patents, foreign patent applications and non-patent publications referred to in this specification and/or listed in the Application Data Sheet are incorporated herein by reference, in their entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A sealed unbonded membrane electrode assembly, comprising:
a first gas diffusion layer and a second gas diffusion layer each having a peripheral border and an active region;
a catalyst coated membrane having an active region, the catalyst coated membrane interposed between the first gas diffusion layer and the second gas diffusion layer; and
a frame member that envelops the peripheral border of the first gas diffusion layer and the second gas diffusion layer and is sealed to the catalyst-coated membrane; and
wherein the catalyst-coated membrane is unbonded to the first and the second gas diffusion layers in the active regions thereof.

2. The sealed unbonded membrane electrode assembly of claim 1 wherein the catalyst-coated membrane has a perimeter edge that does not extend beyond the peripheral border of the first and the second gas diffusion layers.

3. The sealed unbonded membrane electrode assembly of claim 1 catalyst-coated membrane has a perimeter edge that extends beyond the perimeter edge of the first and the second gas diffusion layers.

4. The sealed unbonded membrane electrode assembly of claim 1 wherein the catalyst-coated membrane has a peripheral border and wherein the frame member is sealed to the peripheral border of the catalyst-coated membrane.

5. The sealed unbonded membrane electrode assembly of claim 1 wherein the frame member impregnates the peripheral border of the first and the second gas diffusion layers.

6. The sealed unbonded membrane electrode assembly of claim 1 wherein the frame member is formed from an injection moldable material.

7. The sealed unbonded membrane electrode assembly of claim 1 wherein the frame member is comprised of a first frame submember and a second frame submember sealed to each other.

8. The sealed unbonded membrane electrode assembly of claim 7 wherein the first and the second frame submembers comprise polyester.

9. The sealed unbonded membrane electrode assembly of claim 7 wherein the first and the second frame submembers are a laminate material.

10. The sealed unbonded membrane electrode assembly of claim 7 wherein first and the second frame submembers each have opposing contacting surfaces wherein at least one of the first and the second frame submembers further comprises an adhesive disposed on the contacting surface.

11. The sealed unbonded membrane electrode assembly of claim 10 wherein the adhesive is selected from the group consisting of a thermoplastic material, a thermosetting material, or combinations thereof.

12. The sealed unbonded membrane electrode assembly of claim 1, further comprising:
a third gas diffusion layer interposed between the first gas diffusion layer and the catalyst-coated membrane, wherein an effective water diffusion constant of the first gas diffusion layer is less than an effective water diffusion constant of the third gas diffusion layer.

13. The sealed unbonded membrane electrode assembly of claim 1 wherein the catalyst-coated membrane has catalyst confined to active region thereof.

14. A fuel cell stack comprising a plurality of fuel cells, each fuel cell comprising a sealed unbonded membrane electrode assembly, the sealed unbonded membrane electrode assembly comprising:
a first gas diffusion layer and a second gas diffusion layer each having a peripheral border and an active region;
a catalyst coated membrane having an active region, the catalyst coated membrane interposed between the first gas diffusion layer and the second gas diffusion layer; and
a frame member that envelops the peripheral border of the first gas diffusion layer and the second gas diffusion layer and is sealed to the catalyst-coated membrane; and
wherein the catalyst-coated membrane is unbonded to the first and the second gas diffusion layers in the active regions thereof.

15. A method of making a sealed unbonded membrane electrode assembly, the method comprising:
providing a first gas diffusion layer, a second gas diffusion layer, each comprising a peripheral border and an active region; and a catalyst-coated membrane interposed therebetween, the catalyst-coated membrane having a perimeter edge and an active area,
enveloping the peripheral borders of the first and the second gas diffusion layers with a first frame member; and
sealing the first frame member to the perimeter edge of the catalyst-coated membrane, wherein the catalyst-coated membrane is not bonded to the first and the second gas diffusion layers in the active areas thereof.

16. The method of claim 15 wherein enveloping the peripheral borders of the first and the second gas diffusion layers with a first frame member further comprises:
providing a first frame material and a second frame material, wherein the first and the second frame materials each comprises a ported wing extending beyond the peripheral borders of the first and the second gas diffusion layers, and extending beyond the perimeter edge of the catalyst-coated membrane.

17. The method of claim 15 wherein sealing the first frame member to the perimeter edge of the catalyst-coated membrane further comprises:
applying at least one of heat and pressure to the first frame member.
